(19) United States
(12) Patent Application Publication
(10) Pub. No.: US 2008/0128053 A1
(43) Pub. Date: Jun. 5, 2008

(54) METHOD OF MANUFACTURING A WELDED METAL PANEL HAVING A HIGH QUALITY SURFACE FINISH

(75) Inventors: Steven W. Jansen, Novi, MI (US); Kevin P. Hamel, Madison Heights, MI (US); Kurt Schwarzwalder, Macomb, MI (US)

Correspondence Address: GIFFORD, KRASS, SPRINKLE,ANDERSON & CITKOWSKI, P.C, PO BOX 7021, TROY, MI, 48007-7021, US

(73) Assignee: Noble Advanced Technologies

(21) Appl. No.: 11/950,523

(22) Filed: Dec. 5, 2007

Related U.S. Application Data
(60) Provisional application No. 60/872,893, filed on Dec. 5, 2006.

(51) Int. Cl. B32B 15/01; B23K 26/24; C21D 1/00

(52) U.S. Cl. 148/400; 148/525; 219/121.64; 428/615

(57) ABSTRACT

In a method for preparing a welded metal panel having a high surface quality a first metal blank and a second metal blank are disposed so that edge portions of the blanks are in an abutting relationship. The blanks are laser welded together utilizing a powdered metal filler so as to produce a weld seam which is convex. A portion of the seam is removed to produce a flush weld seam between the blanks. The hardness of the weld seam is determined, and if the hardness of the weld seam is more than the hardness of the remainder of the panel, the weld seam is tempered so as to reduce its hardness. The thus produced welded metal panel may be subjected to a further shaping operation such as stamping, bending or the like. After shaping, the article may be plated, painted or otherwise finished.

### CROSS-REFERENCE TO RELATED APPLICATIONS

This application claims priority of U.S. Provisional Patent Application Ser. No. 60/872,893 filed Dec. 5, 2006, and entitled “Method of Manufacturing Class A Exposed Laser Welded Automotive Body Panels and Automotive Panels Formed Thereby.”

### FIELD OF THE INVENTION

This invention relates generally to the fabrication of metal panels used as structural elements in articles of manufacture including automotive bodies. More specifically the invention relates to the fabrication of such metal panels from a plurality of blanks which are welded together. Most specifically the invention relates to methods and apparatus for preparing laser welded metal panels which maintain a high quality surface finish through shaping and finishing operations.

### BACKGROUND OF THE INVENTION

Stock metal panels are used to fabricate a variety of articles of manufacture including automobile and other vehicular body structures, appliances, and the like. In many instances, for reasons of economy and/or convenience, such panels are prepared from a number of separate metal blanks which are welded together in an edge-to-edge relationship to create a particular panel configuration. Such panels are generally subjected to further forming operations in which they are bent, stamped, stretched, or otherwise shaped into a particular configuration. Thereafter, the shaped members are frequently finished by painting, plating, polishing, anodizing, or otherwise providing a surface finish thereupon. It has been found that in many instances, presence of the welded seam interferes with the surface appearance of the final product. This may result from the fact that portions of the welded seam behave in a manner different from the remainder of the panel when subjected to a forming operation. Also, in some instances it has been found that even if the appearance of the seam is not manifest in the final, shaped article, the seam will still “show through” when the surface finish is applied.

The appearance of the seam may not be critical in those instances where it is disposed on an inner surface of an article. However, exterior surfaces of automobile bodies or other portions of an article of manufacture which are visible to the consumer are required to have a high quality surface finish and the presence of such seams can create a problem.

In industry, and in the automotive industry in particular, it is generally required that articles have what is termed as a “Class A” surface finish. While there is no universally accepted definition of a Class A finish, the automotive industry in America generally recognizes a Class A finish as having parameters defined by a Definition of Image (DOI) of at least 80 and at a Retained Gloss of at least 70. In this regard, see U.S. pending Patent Application 2006/0038325 which discusses these parameters and references various methods for their measurement. The disclosure of this application is incorporated herein by reference. Discussion of Class A finishes in the context of automotive applications is also found in published Patent Application 2007/018429, and published Patent Application 2004/0118488 discusses Class A finishes with regard to metal articles. In addition to Class A finishes, the automotive industry also classifies finishes as “Class B.” These finishes are high quality finishes, but are of somewhat lesser quality than are Class A finishes. These terms as understood in the industry will be used in the context of this disclosure.

There is a need in the industry for methods and/or systems which allow for the use of economical welded panel members in processes for the fabrication of vehicular components and the like, which methods and systems allow for the manufacture of articles having high quality Class A or Class B surface finishes. Any such methods and systems should be compatible with presently employed manufacturing processes, economical, simple to implement, and should not unduly burden the speed of the production process.

As will be explained in detail hereinbelow, the present invention has identified particular factors which have heretofore prevented the use of welded panels in forming processes for the preparation of motor vehicle components and other such articles of manufacture, wherein high quality surface finishes are required. These and other details of the invention will be apparent from the drawings, discussion and description which follow.

### BRIEF DESCRIPTION OF THE INVENTION

Disclosed herein is a method for preparing a welded metal panel having a high surface quality. According to the method, a first metal blank and a second blank are disposed so that an edge portion of the first blank is in an abutting relationship with an edge portion of the second blank, and a first surface of the first blank and a first surface of the second blank are generally coplanar. The abutting edge portions of the blanks are welded together in a laser welding process so as to form a weld seam. A powdered metal filler is applied to the seam during the welding steps, and the welding process is carried out so as to produce a convex weld seam. A portion of the convex weld seam is then removed so as to produce a flush weld seam between the first surfaces of the first and second blanks. The hardness of the convex or flush weld seam is determined and if the hardness of the seam is more than the hardness of the blanks, then the weld seam is tempered so as to reduce its hardness. In some instances, the seam is tempered only if its hardness is at least 1.5 times the hardness of the blanks; while in other instances, the seam is tempered only if its hardness is more than 2.0 times the hardness of the blanks.

In specific instances, the blanks are steel, and the powdered metal used in the welding process is steel. The step of removing a portion of the convex seam may include grinding away a portion of the seam. The step of tempering may be carried out by laser heating, resistive heating, inductive heating, or in a furnace.

Further disclosed is a method for manufacturing a unitary, shaped metal panel wherein welded panels produced in accord with the foregoing method are subsequently shaped and optionally provided with a finish coat.

### BRIEF DESCRIPTION OF THE DRAWINGS

FIG. 1 is a depiction of first and second blanks disposed so as to have portions of their respective edges in an abutting relationship;

FIG. 2 is a schematic depiction of a laser powder metal welding process as being utilized to weld the blanks of FIG. 1; and

FIG. 3 is a schematic depiction of the step of removing a portion of the convex seam between portions of the two welded blanks.

### DETAILED DESCRIPTION OF THE INVENTION

The present invention recognizes that one significant factor which can prevent the achievement of a high quality surface finish in articles fabricated from welded metal workpieces is the hardness of the weld seam, and specifically the hardness differential between the seam and the remainder of the material. While not wishing to be bound by speculation, it is believed that this differential in hardness can create stresses and strains in the workpiece when it is being stamped or otherwise formed. As a result, the shaped article may have an irregular surface in the regions where the weld seam is bent, stretched or otherwise deformed. Also, this differential in hardness may create internal stresses in the material which are manifest in the finished article. In view of this finding, the present invention operates to minimize the hardness differential between the weld seam and the remainder of the material.

The present invention further recognizes that the quality of the weld seam itself can also influence the surface finish of an article. In that regard, the invention utilizes a laser welding process in which powdered metal is applied to the weld seam as a filler thereby minimizing gaps, pits, or other such irregularities. Furthermore, the welding process is implemented so as to produce a convex weld seam which is subsequently reduced in thickness by grinding, polishing or the like. In this manner, the thus produced weld seam is free from significant imperfections which could harm the finish of the final product. As will be described in further detail, these particular features of the present invention operate to allow for the production of finished articles of manufacture having high quality surfaces such as a Class A or Class B surface.

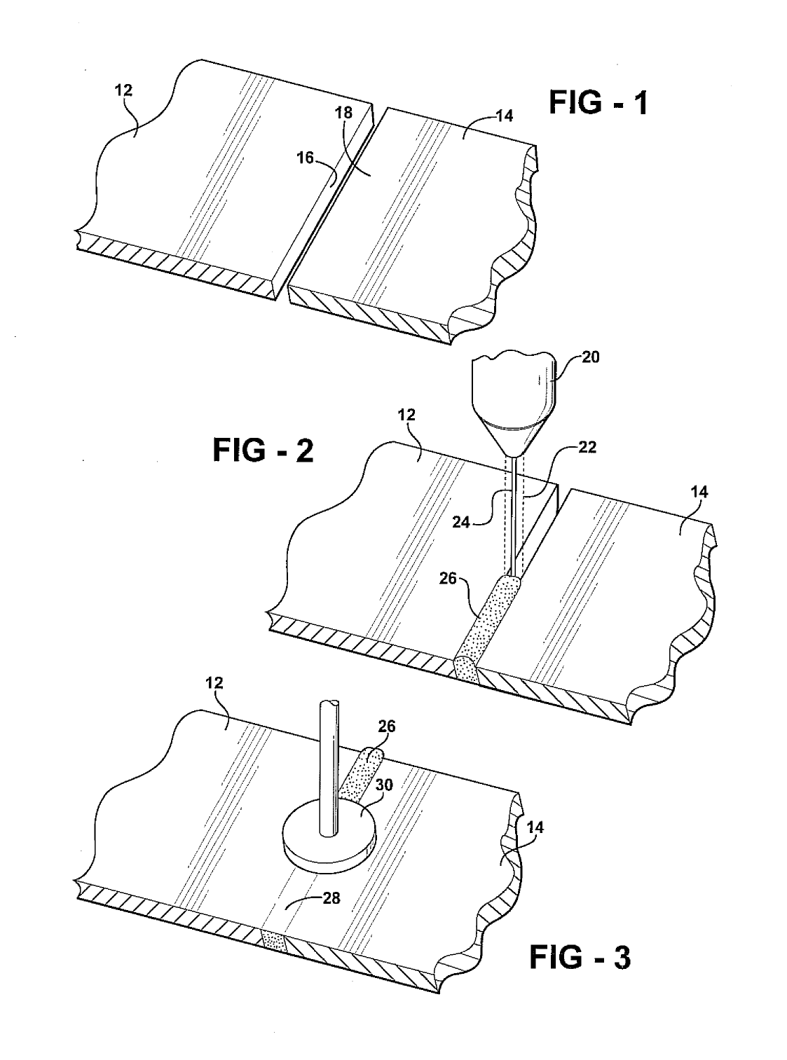

In a first step of a typical process of the present invention, as is shown in FIG. 1, a first metal blank 12 and a second metal blank 14 are disposed in a side-by-side relationship so that an edge portion 16 of the first blank 12 is in an abutting relationship with an edge portion 18 of the second blank 14. For purposes of illustration in FIG. 1, the edges 16 and 18 are shown in a relatively spaced-apart relationship; although, it is to be understood that in many instances they will be in, or nearly in, contact. Also, in FIG. 1, the blanks 12 and 14 are shown as being of the same thickness. In some applications, such will be the case; however, the present invention is not limited in this regard, and may be practiced with blanks of differing thicknesses. Also, the edges 16, 18 in the FIG. 1 embodiment are shown as being straight, it is to be understood that in many instances, these edges may be correspondingly curved. In most applications, the blanks will be formed from a ferrous alloy such as steel; however, the present invention is not limited to ferrous materials and may be utilized in combination with other metals such as titanium alloys, nickel alloys, and so forth. And, the blanks may be made from the same or differing materials.

Referring now to FIG. 2, there is shown a further step in the process wherein the first blank 12 and the second blank 14 are laser welded together. As illustrated, welding is accomplished by a laser system 20 which is operative to deliver a laser beam 22 and a stream of powdered metal 24 to the region being welded.

The method may be implemented using various powder laser welding systems as are known and available in the art. Such systems generally employ high-intensity lasers such as Nd:YAG lasers, CO₂ lasers, and fiber lasers, among others. Welding may be accomplished in either the conduction or keyhole mode. In conduction welding, the beam is generally projected so as to heat the surface or upper portions of the metals being welded, and conduction of this heat to the deeper portion causes melting and welding. In keyhole welding, the beam is projected so as to directly irradiate and melt the deeper portions of the abutting edges of the metals. While either mode of operation may be utilized in the present invention, in general, conduction welding is preferred in particular applications since it generally tends to produce a better surface quality in the weld.

The level of laser power used in the process will depend upon the nature and thickness of the metals being welded. In particular instances, power levels range from approximately 1200 watts per centimeter squared up to 10,000 watts per centimeter squared for applications involving steel alloys. The laser power may be applied in either a continuous or pulsed mode. In a pulsed mode, energy per pulse can range between 1 mJ to 1 kJ and pulse length can be from 1 ms to 1 ns and the pulse repetition rate can be in the range of from about 0.1/s to about 1000/s. Again, specific parameters will depend upon the nature of the materials being welded. As is known in the art, the weld region may be blanketed with an inert gas such as helium or argon.

In the method of the present invention, a powdered metal filler is applied to the weld, and as is shown in FIG. 2, the metal is applied in a stream 24 which is generally concentric with the laser beam 22. In other implementations of the invention, the metal may be applied from a separate dispenser and may be applied in a linear pattern with the weld. The metal powder serves to fill defects in the weld. Typically, the metal powder is of a similar composition to that of the materials being welded. In certain instances, the process has been implemented utilizing a low alloy steel powder sold by the North American Höganäs corporation under the designation Low Alloy Steel Powder (Annealed) Grade 4600. Similar materials are available from other suppliers and may likewise be used in this invention. In yet other instances, this invention has been practiced utilizing a stainless steel powder. Depending on particular applications, other metal powders may be employed.

Systems for laser powder welding are known in the art and various commercially available systems may be readily adapted for the present invention. One particular powder feeder which was employed in a specific implementation of the invention was sold by the Thermach corporation under Model No. AT-1200. A specific coaxial head for delivering laser power and a powdered metal which was used in this particular implementation is available from the Precitec corporation under the designation Cladding Head YC50. The foregoing apparatus has been used in one particular implementation, and it is to be understood that other such apparatus may be readily adapted for the present invention.

As is shown in FIG. 2, the welding process is carried out so as to form a weld seam 26 which is a convex seam insofar as it projects above the surface of the blanks 12, 14. Use of a process which produces a convex seam assures that the weld joint will be of uniformly high quality.

In a further step of the process, as is shown in FIG. 3, a portion of the convex weld seam 26 is removed so as to produce a flush weld seam 28 between the now joined first blank 12 and second blank 14. In the illustration of FIG. 3, a grinding wheel 30 is employed to reduce the convex seam; however, in other implementations of the invention, a belt grinder, a sander, or any other such tool capable of removing the metal may be employed. A multi-step process may be used for reducing the convex seam 26, and such process may include further steps such as sanding, polishing, electrolytic treatments and the like.

As noted above, it has been found that control of the hardness differential between the seam and the remainder of the welded body panel is an important parameter in assuring that a finished article prepared therefrom will have a high surface quality. In this regard, another step of the present invention involves determining the hardness of the weld seam and the remainder of the welded panel to determine the differential therebetween. This step is typically carried out by taking measurements after the convex portion of the seam has been removed, but may in some instances be carried out prior to this step. For practical reasons, the hardness is generally measured using an indentation method where an indenter typically made from diamond is impressed into the material at a preselected loading. The length of the indentation made by the indenter is measured microscopically and is correlated with the hardness of the material. Hardness measurements made according to this method are termed “micro-hardness.” In the present invention, the hardnesses of both the seam and the remainder of the material are measured, and if it is determined that the hardness of the harder of the two (typically the weld seam) is more than 2.0 times (and in particular instances, 1.5 times) the hardness of the softer of the two (typically the remainder of the panel), the hardness of the harder of the two is reduced by tempering so as to reduce the hardness differential. In those instances where it is determined that the hardness differential is not too great no tempering is needed. Tempering may be accomplished by heating only the overly hard portion, or by heating the entire welded panel. Such heating may be carried out in a furnace, by electrical resistance heating, by induction heating, or by laser heating.

In addition to being measured by an indentation method, hardness may also be measured by other methods known in the art. Also, hardness need not be directly measured for every individual workpiece being prepared in accord with the present invention. In those instances where like materials are being laser powder welded under lice conditions with good process control, the step of hardness determination may be carried out by measuring the hardness of selected members of a batch and extrapolated to all members of that batch in accord with accepted quality control protocols, and such extrapolated measurements shall also be considered to be hardness determinations in accord with the teaching and claims of this patent.

Further in accord with the present invention, it has been found that in many instances use of a laser powder welding process in a conduction heating mode provides a heating/cooling profile in the area of the weld seam which is such that the finished seam has a hardness which is sufficiently similar to the hardness of the remainder of the blanks so that further tempering is unnecessary. Thus, once such a welding process is appropriately put in place for a particular configuration and combination of materials, an appropriate hardness differential will be reliably achieved. Thus individual hardness measurements need not be taken on each member as the process proceeds, since hardness is “determined” within the scope of the claim limitations by the conduction welding process. Furthermore, since the determined hardness is within the desirable range, no further tempering will be required.

The resultant panel produced by the above-described methods is comprised of one or more blanks welded together and having a flush weld seam which has a hardness which differs from the hardness of the remainder of the panel by no more than 2.0 times, and in particular instances no more than 1.5 times. In accord with the present invention it has been found that such panels may subsequently be subjected to shaping and/or finishing operations and articles of manufacture produced thereby have a high quality surface finish which is equal to a Class A or Class B finish as is understood in the automotive industry in America.

Disclosed herein are particular embodiments and implementations of the present invention. It is to be understood that other embodiments and implementations will be readily apparent to those of skill in the art in view of the teaching presented herein. Thus, the foregoing drawings, description and discussion should be understood to be illustrative of particular embodiments of the invention and are not limitations upon the practice of this invention. It is the following claims, including all equivalents, which define the scope of the invention.

1. A method for preparing a welded metal panel having a high surface quality, said method comprising the steps of:
providing a first metal blank;
providing a second metal blank;
disposing said blanks so that an edge portion of the first blank is in an abutting relationship with an edge portion of the second blank, and a first surface of the first blank, and a first surface of the second blank are coplanar;
laser welding abutting edge portions of the first blank and the second blank together so as to form a weld seam, while applying a powdered metal filler to said weld seam so that said weld seam is a convex seam;
removing a portion of said convex seam so as to produce a flush weld seam between the first surfaces of said first and second blanks; and
determining the hardness of said convex or flush weld seam and if the hardness of said weld seam is more than 1.5 times the hardness of said blanks, then tempering said weld seam so as to reduce its hardness.

2. The method of claim 1, wherein the weld seam is tempered only if its hardness is more than 2.0 times the hardness of said blanks.

3. The method of claim 1, wherein said blanks are steel.

4. The method of claim 1, wherein said powdered metal is powdered steel.

5. The method of claim 1, wherein said step of removing a portion of said convex seam includes the step of grinding away a portion of said convex seam.

6. The method of claim 1, wherein the step of removing a portion of said convex seam comprises polishing said convex seam.

7. The method of claim 6, wherein said seam is polished to provide at least a Class B finish.

8. The method of claim 1, wherein said step of determining the hardness of said seam comprises measuring the micro-hardness of the seam.

9. The method of claim 1, wherein said step of tempering said seam comprises heating said seam.

10. The method of claim 1, wherein said step of tempering said seam comprises heating said seam and said blanks.

11. The method of claim 1, wherein said step of heating said seam comprises heating said seam by laser irradiation.

12. The method of claim 1, wherein said step of tempering said seam comprises inductively or resistively heating said seam.

13. The method of claim 1, wherein said step of laser welding is implemented in a conduction welding process.

14. The method of claim 1, wherein said step of laser welding is implemented in a keyhole welding process.

15. The method of claim 1, wherein the thickness of said first blank is different from the thickness of said second blank.

16. The method of claim 1, wherein said blanks are comprised of different metals.

17. A welded metal panel prepared by the method of claim 1.

18. A method for manufacturing a unitary, shaped metal panel from a first and a second metal blank, said method comprising the steps of:
providing a first metal blank;
providing a second metal blank;
disposing said blanks so that an edge portion of the first blank is in an abutting relationship with an edge portion of the second blank, and a first surface of said first blank, and a first surface of said second blank are coplanar;
laser welding abutting portions of the first blank and the second blank together so as to form a weld seam, while applying a powdered metal filler to said weld seam so that said weld seam is a convex seam which joins said blanks into a unitary panel;
removing a portion of said convex seam so as to produce a flush weld seam between the first surfaces of said first and second blanks;
determining the hardness of said convex or flush weld seam; and if the hardness of said weld seam is more than the hardness of said panel, then tempering said weld seam so as to reduce its hardness; and
carrying out a shaping process on said panel.

19. The method of claim 18 including the further step of applying a finish to said panel after said shaping operation has been implemented.

20. The method of claim 19, wherein said finish comprises a plated finish or a painted finish.

21. A method for preparing a welded metal panel having a high surface quality, said method comprising the steps of:
providing a first metal blank;
providing a second metal blank;
disposing said blanks so that an edge portion of the first blank is in an abutting relationship with an edge portion of the second blank, and a first surface of the first blank, and a first surface of the second blank are coplanar;
laser welding abutting edge portions of the first blank and the second blank together in a conduction welding mode so as to form a weld seam, while applying a powdered metal filler to said weld seam so that said weld seam is a convex seam and while maintaining the parameters of the welding process so that the hardness of the seam is no more than 2.0 times the hardness of said blanks; and
removing a portion of said convex seam so as to produce a flush weld seam between the first surfaces of said first and second blanks.
